(19) United States
(12) Patent Application Publication
(10) Pub. No.: US 2025/0328381 A1
(43) Pub. Date: Oct. 23, 2025

(54) System and Method for Collapse-Based Compute Orchestration Using Interference Fields and Optional Wave Equations

(71) Applicant: LARRY LIM KHENG CHEONG, SINGAPORE (SG)

(72) Inventor: LARRY LIM KHENG CHEONG, SINGAPORE (SG)

(21) Appl. No.: 19/245,340

(22) Filed: Jun. 22, 2025

(51) Int. Cl. G06F 9/48; G06F 17/12

(52) U.S. Cl. CPC G06F 9/4881; G06F 17/12; G06F 2209/486

(57) ABSTRACT

This invention provides a system and method for orchestrating computational task execution using interference-based collapse fields. Compute nodes activate based on localized interference conditions rather than traditional schedulers or queues. Two embodiments are presented: a general superposition-based logic model and a physics-grounded formulation using the Total Wave Modified Schrödinger Equation (TWMSE). The approach enables decentralized, low-latency, and energy-efficient computation across distributed environments. Applications include AI inference, edge computing, neuromorphic hardware, and robotic control systems. This paradigm replaces centralized scheduling with field-triggered activation, offering a scalable alternative to classical clustering systems.

### CROSS-REFERENCE TO RELATED APPLICATIONS

This application claims priority to and incorporates by reference all contents of the concurrently submitted publication titled “TWMSE as a Collapse-Orchestrated Alternative to Classical Chip Clustering,” available upon patent filing.

### FIELD OF THE INVENTION

The present invention relates generally to compute orchestration systems. More particularly, it concerns methods and systems for dynamic, field-driven orchestration of compute resources using collapse logic derived from either abstract mathematical superposition or physics-grounded wave interference mechanisms, including but not limited to the Total Wave Modified Schrödinger Equation (TWMSE).

### BACKGROUND OF THE INVENTION

In classical computing environments, task execution across CPUs, GPUs, or distributed networks is governed by instruction schedulers, queue management, and polling mechanisms. These centralized methods introduce latency, incur energy penalties, and become bottlenecks in post-Moore architectures such as AI inference systems, edge devices, and robotic swarms.

The growing complexity of real-time, decentralized computing environments demands a fundamentally new orchestration approach—one that eliminates traditional bottlenecks and enables reactive, context-aware computation.

### SUMMARY OF THE INVENTION

The invention provides a method and system for orchestrating task execution using field-based interference logic. Compute nodes receive interference signals emitted by tasks modeled as wave sources. Execution is locally triggered when the resulting collapse field exceeds a predefined threshold.

This orchestration can be instantiated in two principal forms:
1. Non-TWMSE Model: A general interference model using cosine-based superposition functions.
2. TWMSE Model: A physics-derived implementation wherein fields evolve according to a modified Schrödinger equation incorporating observer-induced collapse dynamics.

Both approaches decentralize scheduling logic, reduce energy and latency costs, and allow real-time adaptation to system demands.

### DETAILED DESCRIPTION OF THE INVENTION

### System Architecture

The system comprises three functional layers:
1. Wave Emitters—These encode tasks or signals as waveforms that propagate in a compute space.
2. Compute Field Grid—Nodes are distributed across a logical or physical space and measure the local interference field.
3. Collapse Activation Layer—Each node locally compares its field intensity against a predefined collapse threshold to trigger execution.

Execution proceeds as follows:
Tasks emit dynamic wave signals.
Waves propagate and interfere across the grid.
Each compute node evaluates its local field strength.
Nodes activate when the field exceeds the collapse threshold.
Resulting activity updates the field and reshapes future computation.

This design removes the need for centralized polling, queues, or clocks.

### (A) Non-TWMSE Embodiment

Each task or agent emits a cosine-based wave. The local collapse field at node i is calculated as:

$$Ci ( t ) = \sum k [ wk \times cos ( θ i k ( t ) ) \times A k ( t ) ]$$

Where:
wk is the weight of source k
θik is the phase offset between node i and source k
Ak(t) is the amplitude of the wave from k

The node activates if:

$$Ci ( t ) > θ collapse$$

This model is suited for implementation in digital systems, software agents, container schedulers, or neural inference frameworks.

### (B) Preferred Embodiment: TWMSE-Based Interference Collapse

In the TWMSE model, each wave evolves according to the Total Wave Modified Schrödinger Equation:

$$i ℏ \partial {Ψ}_{p} / \partial t = [ - ( {ℏ}^{2} / 2 m ) {∇}^{2} + V ( r , t ) ] {Ψ}_{p} + \sum j [ γ j {\vert Ψ j \vert}^{2} - δ j Re ( Ψ j ) ] {Ψ}_{p}$$

The resulting collapse field is:

$$C ( r , t ) = \sum j [ γ j {\vert Ψ j \vert}^{2} - δ j Re ( Ψ j ) ]$$

A node activates when:

$$C ( r , t ) > θ collapse$$

TWMSE implementations can be realized in quantum simulators, analog devices, neuromorphic substrates, or hybrid field-programmable architectures.

### Applications

AI Inference Engines: Real-time prioritization of deep learning layers or transformers via collapse-based logic
Edge Computing/IoT: Self-organizing swarm coordination and distributed logic using interference fields
Neuromorphic Computing: Emulating biological phase coherence for energy-efficient signal routing
Robotics/Control Systems: Phase-driven task scheduling across multiple autonomous agents

### Advantages Over Prior Art

Eliminates polling and queue management
Supports both abstract and physical models of interference
Reduces latency and energy consumption
Compatible with digital, analog, and neuromorphic substrates
Enables scalable, real-time, distributed orchestration

What is claimed is:

1. A system for orchestrating compute task execution using field-based collapse logic, comprising:
a plurality of task sources configured to emit signal fields representing computation intent;
a plurality of compute nodes distributed across a space, each configured to sense local interference;
a collapse threshold comparator embedded within each compute node;
wherein each compute node initiates execution when the local interference field exceeds a predefined collapse threshold.

2. The system of claim 1, wherein the interference field is computed using cosine-based amplitude and phase signals:
$${C}_{i} ( t ) = {\sum }_{k = 1}^{N} {w}_{k} \cdot cos ( {θ}_{i k} ( t ) ) \cdot {A}_{k} ( t )$$

3. The system of claim 1, wherein the interference field is governed by a modified Schrödinger equation comprising:
$$i ℏ \frac{\partial {Ψ}_{p}}{\partial t} = [ - \frac{{ℏ}^{2}}{2 m} {∇}^{2} + V ( r , t ) ] {Ψ}_{p} + {\sum }_{j} ( {γ}_{j} {\vert {Ψ}_{j} \vert}^{2} - {δ}_{j} Re [ {Ψ}_{j} ] ) {Ψ}_{p}$$

4. The system of claim 3, wherein a node initiates execution if:
$$C ( {r}_{i} , t ) = {\sum }_{j} ( {γ}_{j} {\vert {Ψ}_{j} \vert}^{2} - {δ}_{j} Re [ {Ψ}_{j} ] ) > {θ}_{c o l l a p s e}$$

5. The system of claim 1, wherein the signal fields are implemented via one or more of:
digital waveform simulations in software containers,
analog signal propagation in neuromorphic hardware,
optical interference in programmable waveguide matrices,
quantum amplitude fields in hybrid simulators.

6. The system of claim 1, wherein compute nodes are configured to modify the in-terference field upon task execution, thereby dynamically reshaping subsequent field values.

7. The system of claim 1, wherein collapse thresholds are adaptive based on:
curvature of the signal field,
local energy consumption levels,
system load,
priority encoding via γⱼ or δⱼ parameters.

8. A method for field-driven compute orchestration comprising:
(a) encoding tasks as signals with amplitude and phase parameters;
(b) emitting signals across a compute grid;
(c) evaluating the local collapse field at each node;
(d) initiating task execution at nodes where the field exceeds a predefined threshold.

9. The method of claim 8, wherein execution modifies the global or local field state, enabling feedback-based adaptive orchestration.

10. The method of claim 8, further comprising tuning the collapse threshold in real-time based on observed system performance or external control inputs.
